(19) United States
(12) Patent Application Publication
(10) Pub. No.: US 2026/0102673 A1
(43) Pub. Date: Apr. 16, 2026

(54) BADMINTON INTELLIGENT TRAINING EVALUTION SYSTEM, METHOD AND NON-TRANSITORY COMPUTER READABLE STORAGE MEDIUM

(71) Applicant: National Cheng Kung University, Tainan City (TW)

(72) Inventors: Jeen-Shing WANG, Tainan City (TW); Wei-Chun CHIANG, Tainan City (TW)

(21) Appl. No.: 18/988,484

(22) Filed: Dec. 19, 2024

(30) Foreign Application Priority Data
Oct. 16, 2024 (TW) 113139428

(51) Int. Cl. A63B 69/00; A63B 24/00; A63B 69/40; A63B 71/06; G06V 10/26; G06V 20/40

(52) U.S. Cl. CPC A63B 69/0017; A63B 24/0003; A63B 69/40; A63B 71/0605; G06V 10/26; G06V 20/42; A63B 2024/004; A63B 2214/00; A63B 2220/05; A63B 2220/807; A63B 2220/833

(57) ABSTRACT

A badminton intelligent training evaluation system, method and storage medium. The badminton intelligent training evaluation system includes a badminton racket, a serving device, two first image capturing devices and a computing device. When one or more instructions are executed by one or more processing units of the computing device, the one or more processing units perform the following procedures: obtaining and analyzing images of a player on the first half court to obtain a vacancy region with respect to the player instantly; controlling the serving device to serve a shuttlecock to fall in the vacancy region according to the obtained vacancy region; and obtaining an image of the shuttlecock returned by the player until falling on a landing point on a second half court, and determining whether the landing point is out of bounds.

### CROSS REFERENCE TO RELATED APPLICATIONS

This Non-provisional application claims priority under 35 U.S.C. § 119(a) on Patent Application No(s). 113139428 filed in Taiwan, Republic of China on Oct. 16, 2024, the entire contents of which are hereby incorporated by reference.

### BACKGROUND

### Technology Field

The present disclosure relates to a system, a method and a storage medium. In particular, the present disclosure relates to a badminton intelligent training system and method and a non-transitory computer readable storage medium.

### Description of Related Art

Badminton is a very common and popular sport. In addition to training players' reaction ability, it also helps to train human endurance, muscles, and even small muscle groups. Therefore, badminton has become an extremely common leisure and sport event.

In order to improve the strike skill, no matter you are a beginner, an experienced player, or even a professional athlete, the frequent defensive and offensive strike practices are needed. The most conventional practice is to do a lot of matches. However, the match requires at least two players. That is, one single player cannot do the match along. In order to improve the inconvenience of practice by one player, various badminton serving machines, which can automatically launch shuttlecocks for practicing returning shots, have been developed.

However, when using the conventional serving machine for practice, the serving machine can only serve the shuttlecocks to the half-court area where the player is located, but cannot specifically shot the shuttlecocks to the vacancy region of the player, so the practice effect is not good. Furthermore, it is often difficult for badminton players to find out the errors and weaknesses in their own movements. Even with a supervisor during the practice, the badminton players still need a lot of practices, and the progress may be extremely slow. Moreover, it is impossible to have a supervisor always around the badminton players during the entire practices and to point out deficiencies and weaknesses immediately.

### SUMMARY

An objective of this disclosure is to provide a badminton intelligent training system and method and a non-transitory computer readable storage medium.

In addition to being able to instantly obtain the player's location for enhancing intelligent serving technology, this disclosure can further determine the landing point of the returned shuttlecock, which is used as a reference for evaluating whether the returned shot is success or not, thereby creating a new intelligent badminton experience.

To achieve the above, this disclosure provides a badminton intelligent training evaluation system, which is applied to a badminton court for training and evaluating an exercising result of a player. The badminton court includes two badminton net stands and a badminton net hanged between the badminton net stands, and the badminton court is divided by the badminton net into a first half court and a second half court. The badminton intelligent training evaluation system includes a badminton racket, a serving device, two first image capturing devices, and a computing device. The badminton racket includes a signal sensing device, and the signal sensing device senses a strike motion of the player with holding the badminton racket on the first half court and outputs a sensing signal. The serving device is arranged at the second half court for serving at least one shuttlecock to the first half court. The first image capturing devices are respectively disposed on the badminton net stands. The first image capturing devices obtain an image of the player on the first half court and an image of the shuttlecock returned by the player until falling on a landing point on the second half court. The computing device is communicational connected to the signal sensing device, the serving device and the first image capturing devices. The computing device includes one or more processing units and a memory unit. The one or more processing units are coupled to the memory unit, and the memory unit stores one or more instructions. The one or more processing units, when executing the one or more instructions, perform: a first procedure of obtaining and analyzing the image of the player on the first half court to obtain a vacancy region with respect to the player instantly; a second procedure of controlling the serving device to serve the shuttlecock to fall in the vacancy region according to the obtained vacancy region; and a third procedure of obtaining the image of the shuttlecock returned by the player until falling on the landing point on the second half court, and determining whether the landing point is out of bounds.

In one embodiment, before obtaining the vacancy region in the first procedure, the one or more processing units further perform: obtaining an image of the first half court by the first image capturing devices and marking corner points of the first half court; and mapping the corner points of the first half court to a top view diagram of the first half court so as to establish a coordinate base for detecting a position of the player on the top view diagram.

In one embodiment, the vacancy region includes a positional vacancy region and a dynamic vacancy region, the positional vacancy region is a region on the first half court farthest from the player, and the dynamic vacancy region is a region on the first half court opposite to a fast moving direction of the player.

In one embodiment, in the second procedure, the computing device controls a serve parameter of the serving device to make the shuttlecock fall within the vacancy region, and the serve parameter includes a serve speed, a serve frequency, a horizontal serve position and a vertical serve position.

In one embodiment, the serve parameter is stored in the memory unit of the computing device or a cloud database.

In one embodiment, after the player returns the shuttlecock in the third procedure, the one or more processing units further perform: tracking position changes of the player on projected images of sequential frames to obtain a running distance of the player in the period of returning the shuttlecock.

In one embodiment, the step of determining whether the landing point is out of bounds in the third procedure includes a court boundary detection step and a landing point detection step. The court boundary detection step includes: obtaining an image of the second half court, and obtaining boundary information based on the image of the second half court, thereby obtaining boundary lines, intersection coordinates and an inbound area of the second half court; and dividing the inbound area into multiple blocks and obtaining coordinates of the blocks. The landing point detection step includes: detecting a flying trajectory of the shuttlecock; and determining whether the landing point is out of bounds based on a result of the court boundary detection step and the flying trajectory of the shuttlecock.

In one embodiment, the one or more processing units further perform: analyzing the sensing signal and calculating a strike parameter corresponding to the strike motion of the player.

In one embodiment, the badminton intelligent training evaluation system further includes a second image capturing device for obtaining an image of the strike motion of the player and an image of the flying shuttlecock, and the one or more processing units further perform: playing the image of the strike motion of the player.

In one embodiment, the one or more processing units further perform: repeating the first procedure, the second procedure and the third procedure until reaching a stop condition.

In one embodiment, the serving device serves a plurality of shuttlecocks, and the one or more processing units further perform: a fourth procedure of generating a smart badminton shot report according to the sensing signal and the landing points of the returned shuttlecocks.

To achieve the above, this disclosure also provides a badminton intelligent training evaluation method, applied to a badminton intelligent training evaluation system for training and evaluating an exercising result of a player. The badminton intelligent training evaluation system is applied to a badminton court, the badminton court includes two badminton net stands and a badminton net hanged between the badminton net stands, and the badminton court is divided by the badminton net into a first half court and a second half court. The badminton intelligent training evaluation system includes a badminton racket, a serving device, two first image capturing devices and a computing device. The badminton racket includes a signal sensing device, and the signal sensing device senses a strike motion of the player with holding the badminton racket on the first half court and outputs a sensing signal. The serving device is arranged at the second half court for serving at least one shuttlecock to the first half court. The first image capturing devices are respectively disposed on the badminton net stands, and are configured to obtain an image of the player on the first half court and an image of the shuttlecock returned by the player until falling on a landing point on the second half court. The computing device is communicational connected to the signal sensing device, the serving device and the first image capturing devices. The badminton intelligent training evaluation method includes the following steps of: obtaining and analyzing the image of the player on the first half court to obtain a vacancy region with respect to the player instantly; controlling the serving device to serve the shuttlecock to fall in the vacancy region according to the obtained vacancy region; and obtaining the image of the shuttlecock returned by the player until falling on the landing point on the second half court, and determining whether the landing point is out of bounds.

To achieve the above, this disclosure further provides a non-transitory computer readable storage medium storing an application software, and an electronic device can load and execute the application software to perform the above-mentioned badminton intelligent training evaluation method.

As mentioned above, the badminton intelligent training evaluation system and method of this disclosure includes the following steps of: obtaining and analyzing the image of the player on the first half court to obtain a vacancy region with respect to the player instantly; controlling the serving device to serve the shuttlecock to fall in the vacancy region according to the obtained vacancy region; and obtaining the image of the shuttlecock returned by the player until falling on the landing point on the second half court, and determining whether the landing point is out of bounds. Therefore, the badminton intelligent training evaluation system and method of this disclosure can instantly obtain the player's location for enhancing intelligent serving technology, and determine the landing point of the returned shuttlecock, which is used as a reference for evaluating whether the returned shot is success or not, thereby creating a new intelligent badminton experience.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1 is a schematic diagram showing a badminton intelligent training evaluation system according to an embodiment of this disclosure;

FIG. 2 is a block diagram of a badminton intelligent training evaluation system according to an embodiment of this disclosure;

FIG. 3 is a flow chart showing the procedures of the badminton intelligent training evaluation system of FIG. 2;

FIG. 4 is a flow chart showing the steps of determining whether the landing point is out of bounds in the badminton intelligent training evaluation system of FIG. 2;

FIG. 5A is a schematic diagram showing the badminton court of FIG. 1;

FIG. 5B is a top view of the badminton court of FIG. 5A;

FIG. 6 is a schematic diagram showing the first half court of the badminton court of FIG. 1, which is divided into nine (3×3) blocks;

FIGS. 7A to 7I are schematic diagrams of the first half court including nine blocks, wherein the position of the player and the positional vacancy regions are indicated;

FIG. 8 is a schematic diagram showing the second half court of the badminton court of FIG. 1, wherein the inbound area of the second half court for single is divided into sixteen blocks; and

FIGS. 9A and 9B are schematic diagrams showing the smart badminton shot reports of the player.

### DETAILED DESCRIPTION OF THE DISCLOSURE

The present disclosure will be apparent from the following detailed description, which proceeds with reference to the accompanying drawings, wherein the same references relate to the same elements.

This application relates to Taiwan Patent No. TWI770787 entitled “HAND-HELD MOTION ANALYSIS SYSTEM AND METHOD”, and Taiwan Patent Application No(s). 112211288 entitled “MOTION SENSING DEVICE AND SPORTS SHOES”, and 112145387 entitled “SYSTEM AND METHOD FOR AUTOMATICALLY CAPTURING AND REPLAYING IMAGES, AND STORAGE MEDIUM”, the entire contents of which are hereby incorporated by reference.

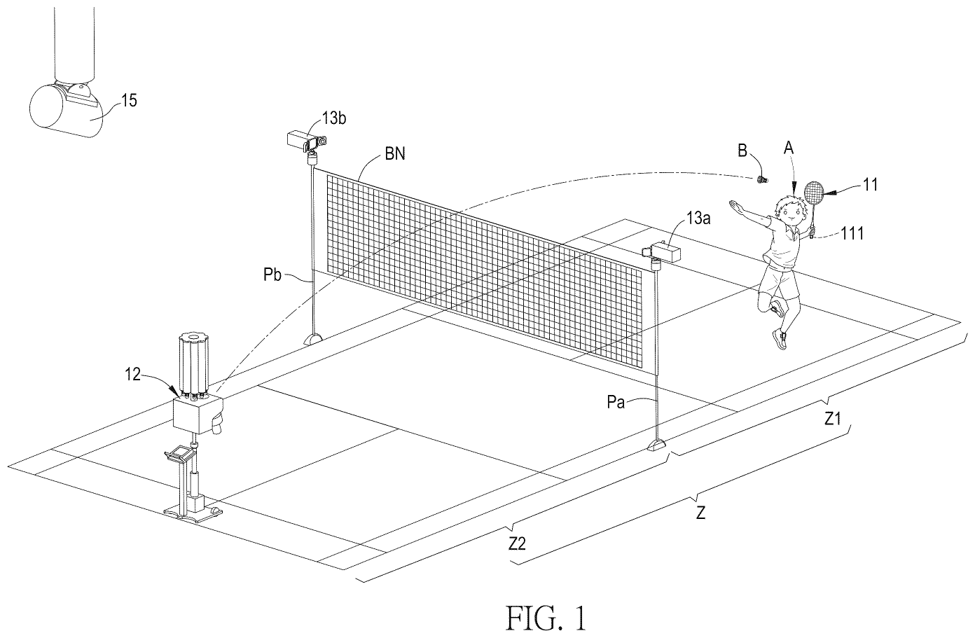

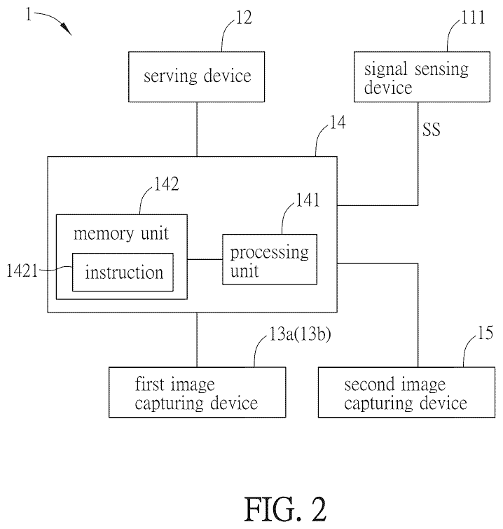

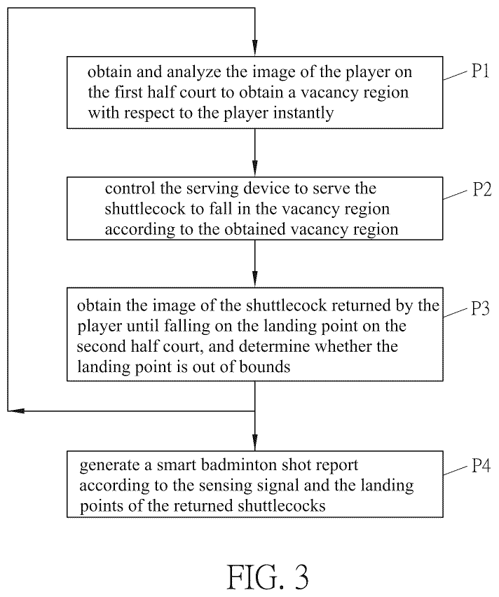

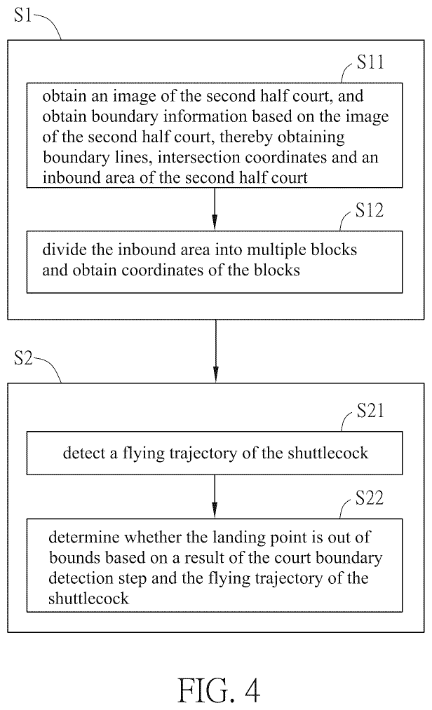

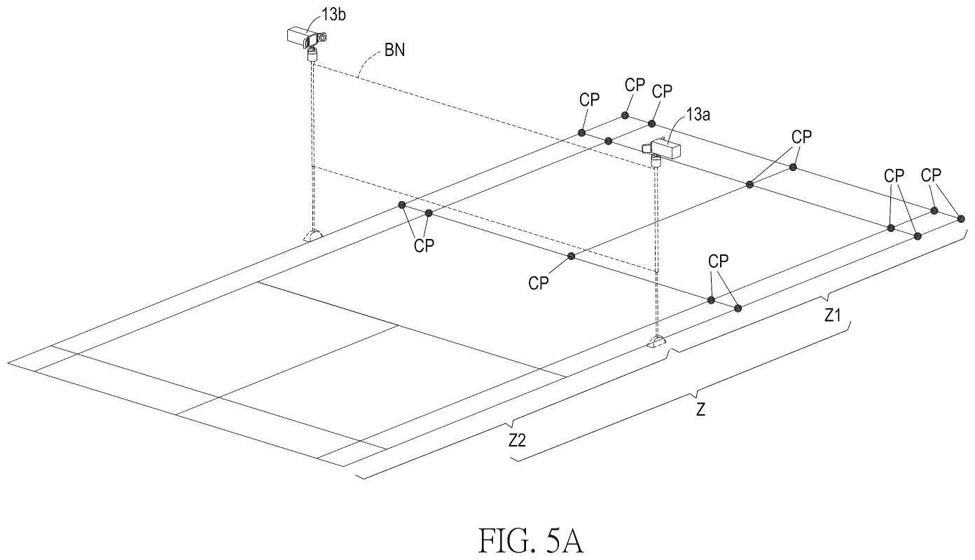

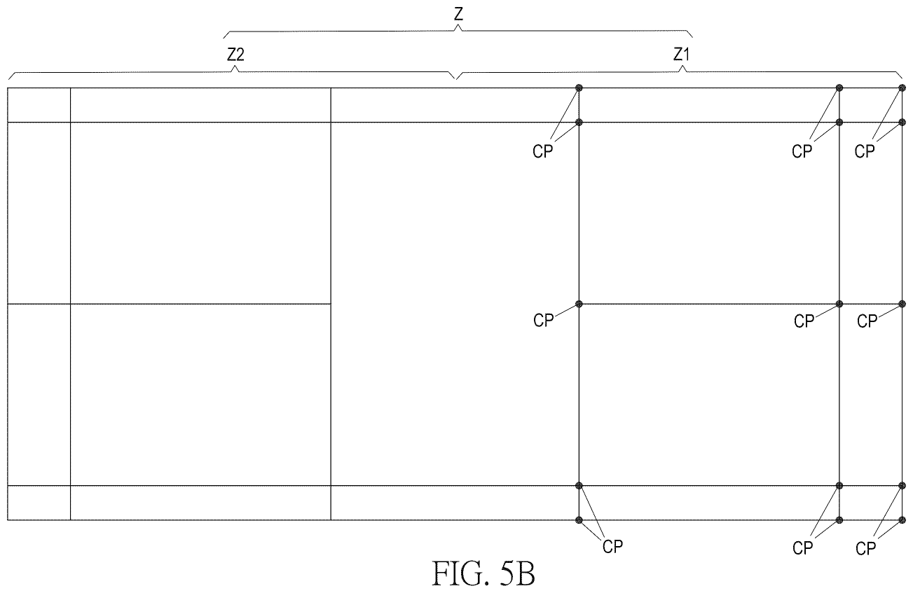

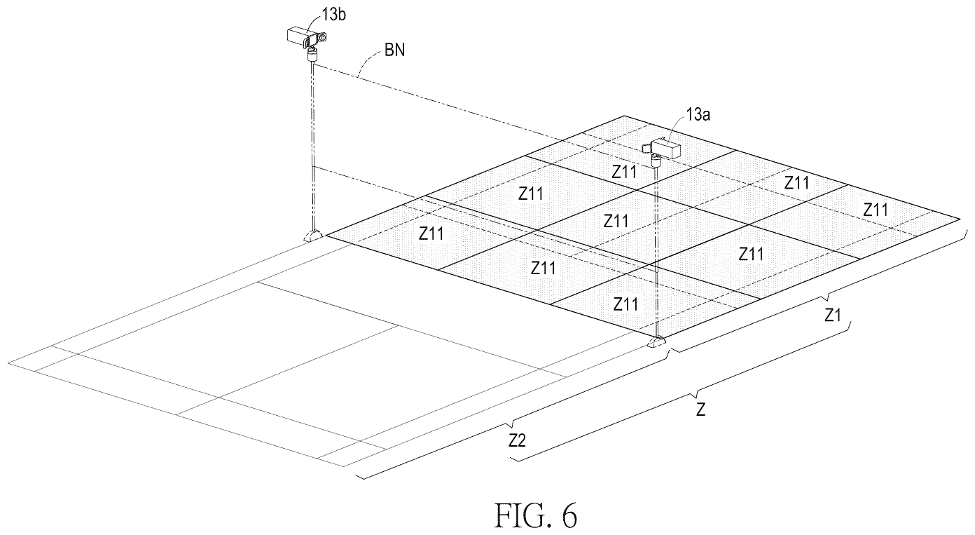

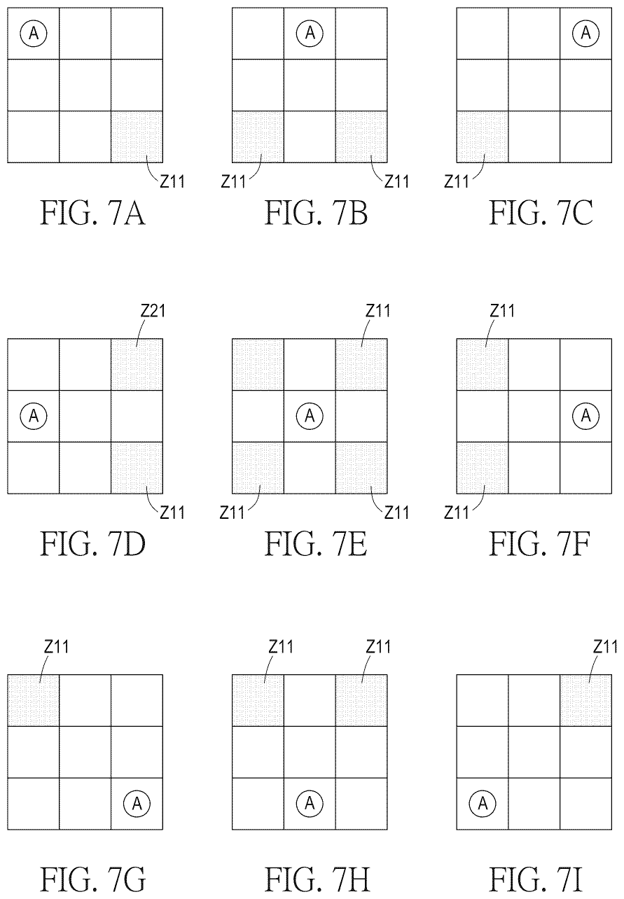

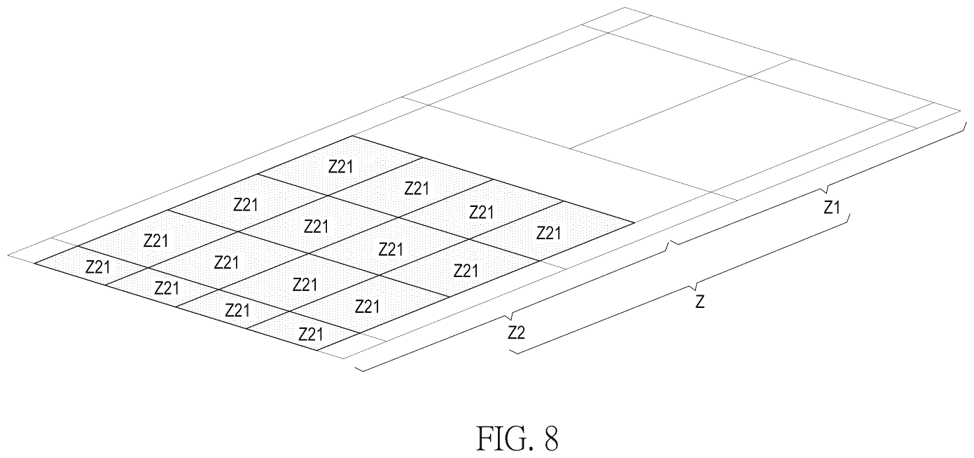

FIG. 1 is a schematic diagram showing a badminton intelligent training evaluation system according to an embodiment of this disclosure. FIG. 2 is a block diagram of a badminton intelligent training evaluation system according to an embodiment of this disclosure. FIG. 3 is a flow chart showing the procedures of the badminton intelligent training evaluation system of FIG. 2. FIG. 4 is a flow chart showing the steps of determining whether the landing point is out of bounds in the badminton intelligent training evaluation system of FIG. 2. FIG. 5A is a schematic diagram showing the badminton court of FIG. 1, and FIG. 5B is a top view of the badminton court of FIG. 5A. FIG. 6 is a schematic diagram showing the first half court of the badminton court of FIG. 1, which is divided into nine (3×3) blocks. FIGS. 7A to 7I are schematic diagrams of the first half court including nine blocks, wherein the position of the player and the positional vacancy regions are indicated. FIG. 8 is a schematic diagram showing the second half court of the badminton court of FIG. 1, wherein the inbound area of the second half court for single is divided into sixteen blocks.

Referring to FIGS. 1 and 2, a badminton intelligent training evaluation system 1 of this embodiment is applied to a badminton court Z for training and evaluating an exercising result of a player A. The badminton court Z includes a badminton net stand Pa, a badminton net stand Pb and a badminton net BN hanged between the badminton net stands Pa and Pb. The badminton court Z is divided by the badminton net BN into a first half court Z1 and a second half court Z2. In this disclosure, each of the first half court Z1 and the second half court Z2 includes a half of the entire badminton court and the region around the boundary lines.

The badminton intelligent training evaluation system 1 includes a badminton racket 11, a serving device 12, two first image capturing devices 13a and 13b, and a computing device 14. In addition, the badminton intelligent training evaluation system 1 may further include a second image capturing device 15.

The badminton racket 11 includes a signal sensing device 111, and the signal sensing device 111 can sense a strike motion (e.g. the swing motion including smash, slow drop shot, or the likes) of the player A with holding the badminton racket 11 on the first half court Z1, and outputs a sensing signal SS. The sensing signal SS can be transmitted to the computing device 14, and the computing device 14 can analyze the received sensing signal SS to obtain some strike parameters. In one embodiment, the signal sensing device 111 can be disposed inside the handle of the badminton racket 11, the handle end cap, or any of other parts of the handle. In this embodiment, the signal sensing device 111 is, for example, disposed inside the handle of the badminton racket 11. Therefore, when the player A holds the badminton racket 11 and swings it, the signal sensing device 111 can sense the player's strike motion (swing motion) and output a sensing signal SS corresponding to the strike motion (swing motion). In general, when the player A executes a plurality of strike motions (swing motions) in a period of time, the output signal is also called a sensing signal SS.

In one embodiment, the signal sensing device 111 may include an inertial sensor, such as, for example but not limited to, a three-axis accelerometer, a three-axis gyroscope, or a three-axis magnetometer, which can obtain the accurate strike motions (swing motions). Therefore, the sensing signal SS is an inertial sensing signal, which may include the acceleration signal, angular velocity signal and magnetic signal during the sporting motion. In one embodiment, a nine-axis inertial sensor, which includes a six-axis sensor (e.g. ICM-20649, TDK InvenSense) and a three-axis magnetometer (e.g. LIS2MDL, digital magnetic sensor) composed of accelerometers and gyroscopes, can be used. In general, the accelerometer is used to sense the acceleration caused by the gravity and movement, the gyroscope is used to sense the angular velocity generated by the movement, and the magnetometer is used to sense the earth magnetic field vector and calculate to obtain azimuth information.

In one embodiment, the signal sensing device 111 may further include a microcontroller unit and a power supply unit. The microcontroller unit can capture and collect the sensing signal SS generated by the inertial sensors (accelerometer, gyroscope and magnetometer) due to the strike motions and process the sensing signal SS (e.g. temporary storing and encoding). The processed sensing signal SS can be wirelessly transmitted to the computing device 14 through, for example, a Wi-Fi module or a Bluetooth module in a batch manner, and the computing device 14 can then perform analysis of the strike motions and returned shots. The power supply unit can be, for example, a lithium battery, which can provide the power required for the operation of the signal sensing device 111.

The serving device 12 is a badminton serving machine, which is located on the second half court Z2. The serving device 12 can serve at least one shuttlecock B to the first half court Z1, so that the player A can swing the badminton racket 11 to practice the return strike motions. In general, the player A can return the shuttlecock B back and make it land on the second half court Z2.

The first image capturing devices 13a and 13b are respectively installed on the badminton net stands Pa and Pb. The first image capturing devices 13a and 13b can obtain an image of the player A on the first half court Z1, and an image of the shuttlecock B served by the serving device 12 and returned by the player A until falling on a landing point on the second half court Z2. Then, the image of the player A on the first half court Z1 and the image of the shuttlecock B served by the serving device 12 and returned by the player A until falling on a landing point on the second half court Z2 can be transmitted to the computing device 14 instantly. In this case, each of the first image capturing devices 13a and 13b and the second image capturing device 15 may include a global shutter photography module, which generally has the global shutter, high frame rate and low distortion lens.

The first image capturing devices 13a and 13b are respectively disposed on the badminton net stands Pa and Pb. In this embodiment, the first image capturing devices 13a and 13b, which are disposed on the badminton net stands Pa and Pb respectively, can be rotatable in 360 degrees horizontally and in 90 degrees vertically, and the user can adjust them in time to obtain a proper strike motion image. Each of the first image capturing devices 13a and 13b of this embodiment includes two cameras. The two cameras can be rotatable in 270 degrees horizontally to meet various usage scenarios in different multifunctional venues. In this case, the badminton net stands Pa and Pb can be portable badminton net stands C-7047 (Victor), and the mobile power supply can be provided to supply power to the first image capturing devices 13a and 13b. Therefore, the additional power lines and network cables are not needed. This design can provide the convenience for moving and installing the equipment in the multifunctional venue, as well as decreasing the risk of collision, tripping and other sports injuries to the player A caused by redundant equipment or cables on the court.

In addition, the second image capturing device 15 can obtain an image of the strike motion of the player A and an image of the flying shuttlecock B. The second image capturing device 15 can be installed at a higher place outside the badminton court Z to capture the image of the strike motions of the player A and the image of the flying shuttlecock B. In one embodiment, multiple second image capturing devices 15 can be installed at different orientations to capture the strike motions at different orientations or angles. The number and installation orientations of the second image capturing devices 15 are not limited in this disclosure, and any configuration that can obtain the clear images of the strike motions of the player A and the flying shuttlecock B is acceptable.

The computing device 14 is communicational connected to the signal sensing device 111, the serving device 12, the first image capturing devices 13a and 13b, and the second image capturing device 15, so that the signal sensing device 111, the serving device 12, the first image capturing devices 13a and 13b, and the second image capturing device 15 can communicate with one another. In this embodiment, the communicational connection between the signal sensing device 111, the serving device 12, the first image capturing devices 13a and 13b, and the second image capturing device 15 can be a wireless communicational connection through, for example, a Bluetooth module or a Wi-Fi module. In this case, the computing device 14 can be, for example but not limited to, a computer, a server or a cloud device (e.g. a remote server).

The computing device 14 of this embodiment may include one or more processing units 141 and a memory unit 142, and the one or more processing units 141 are coupled to the memory unit 142. As shown in FIG. 2, in this embodiment, the computing device 14 includes, for example, one processing unit 141 and one memory unit 142. The processing unit 141 can access the data stored in the memory unit 142, and may include the core control components of the computing device 14, such as a central processing unit (CPU) and a memory, or may include other control hardware, software or firmware. This disclosure is not limited thereto. In this case, the sensing signal SS outputted by the signal sensing device 111 after sensing the strike motions of the player A, and the images obtained by the first image capturing devices 13a and 13b and the second image capturing device 15 can be transmitted to the computing device 14 and then stored in the memory unit 142, so that the processing unit 141 can process and analyze these data stored in the memory unit 142 later.

The memory unit 142 can be a non-transitory computer readable storage medium, which may at least include, for example but not limited to, a memory unit, a memory card, an optical disc, a video tape, a computer tape, or any combination thereof. In one embodiment, the aforementioned memory unit may include a read-only memory (ROM), a flash memory, a FPGA (Field-Programmable Gate Array), an SSD (Solid State Disk), any of other kinds of memory, or a combination thereof. In this embodiment, the memory unit 142 can store at least one application software, which includes one or more instructions 1421. When the one or more instructions 1421 of the application software are executed by the one or more processing units 141, the one or more processing units 141 can perform the following procedures, including the first procedure P1 to the fourth procedure P4 as shown in FIG. 3.

The first procedure P1 is to obtain and analyze the image of the player on the first half court to obtain a vacancy region with respect to the player instantly. Specifically, the result of the first procedure P1 can be used to control the serving device 12 to serve the shuttlecock B to the vacancy region with respect to the player A, thereby providing users with the experiences of various shuttlecock serve paths while increasing the training intensity of the player A.

To be noted, before the first procedure P1, the computing device 14 needs to perform a pre-treatment of the images obtained by the first image capturing devices 13a and 13b to establish a correspondence between the badminton court field in the images and the top view diagram. This information can be used to control the serving device to serve the shuttlecock toward the vacancy region and to evaluate the running distance of the player A.

For example, the computing device 14 can receive the image of the first half court Z1 obtained by the first image capturing devices 13a and 13b, and then mark the corner points CP of the first half court Z1 in the first half court Z1 (see FIG. 5A). Then, the computing device 14 can map the corner points CP of the first half court Z1 to a top view diagram of the first half court Z1 (see FIG. 5B) so as to establish a coordinate base for detecting a position of the player A on the top view diagram. To be noted, since the first half court Z1 and the second half court Z2 are symmetrical to each other, if all the coordinates of the first half court Z1 are known, all the coordinates of the second half court Z2 can be calculated and obtained. Then, the obtained coordinates of the second half court Z2 can be used to determine the landing point of the shuttlecock B.

Specifically, after obtaining the image of the first half court Z1, the computing device 14 can mark all the corner points CP (as shown in FIG. 5A) in the image of the first half court Z1 based on a boundary detection algorithm. Next, all the corner points CP marked in the image are mapped to the positions of the corresponding corner points CP on the top view diagram of FIG. 5B by a homography method. Through such pre-treatment, the coordinate points required for subsequently detecting the coordinates on the top view diagram representing the position of the player A on the first half court Z1 can be established.

Afterwards, an object tracking technology (e.g. for example but not limited to ByteTrack tracker) can be used to capture the position of player A in the image in real time, and then the position of player A can be projected on the top view diagram of the first half court Z1 by using the above-mentioned homography method. The projected position will become the input for the detection of vacancy region, the serving algorithm of the serving device 12, and the running distance evaluation algorithm of the player A, thereby controlling the serving device 12 to send the shuttlecock B to land on the vacancy region and evaluating the running distance of the player A.

Referring to FIG. 3 again, in the first procedure P1, the vacancy region of the player A may include two types of vacancy regions, a positional vacancy region and a dynamic vacancy region. In this embodiment, the positional vacancy region is the region on the first half court Z1 farthest from the player A, and the dynamic vacancy region is the region on the first half court Z1 opposite to a fast moving direction of the player A.

Specifically, as shown in FIG. 6, in order to serve the shuttlecock B to land on the vacancy region, the first half court Z1 is divided into, for example, nine regions Z11 (i.e. 3×3 blocks) in advance. Each region Z11 has the same size and is configured corresponding to the six corner footwork of the player A, and the projection of the real-time position of the player A can be correspondingly referred to these nine regions Z11. For example, as shown in FIGS. 7A to 7I, the circle “O” represents the region where the player A is located, and the regions Z11 filled with the hatch lines represent the vacancy regions. To be understood, one or more regions Z11 can be determined as the vacancy region(s). For example, there are two regions Z11 in FIGS. 7B, 7D, 7F, and 7H being determined as the vacancy regions, and there are four regions Z11 in FIG. 7E being determined as the vacancy regions. Therefore, the computing device 14 can randomly select a coordinate point within the vacancy region(s) (the regions Z11 filled with hatch lines) as the target landing point for the next serving of the serving device 12, and then the computing device 14 can control the serving device 12 to serve the shuttlecock to land on the selected coordinate point within the vacancy region.

In order to serve the shuttlecock to land on the dynamic vacancy region, the prediction result of the above-mentioned ByteTrack tracker can be used to obtain the possible moving direction of the player A. That is, the position changes of the player A in the sequential frames obtained by the first image capturing devices 13a and 13b can be analyzed to obtain the instant moving direction of the player A. Then, the serving device 12 can be controlled to serve the shuttlecock B toward the region opposite to the moving direction of the player A.

After obtaining the vacancy region(s) of the player A in the first half court Z1, the one or more processing units 141 can perform a second procedure P2 of controlling the serving device to serve the shuttlecock to fall in the vacancy region according to the obtained vacancy region. In this embodiment, the computing device 14 can control a serve parameter of the serving device 12 to make the shuttlecock B precisely fall within the vacancy region. The serve parameter may include a serve speed, a serve frequency, a horizontal serve position and a vertical serve position.

Specifically, in order to provide users with the experiences of various shuttlecock serve paths while increasing the training intensity of the users, the badminton intelligent training evaluation system 1 of this embodiment has the function of customizing the shuttlecock serve paths, which allows the user to adjust different serve parameters, including different serve speeds, serve frequencies, horizontal serve positions and vertical serve positions, according to personal needs, and to define and control the movement of shuttlecock by instructions so as to simulate various shuttlecock serve paths. In this case, the serve speed refers to the speed of the shuttlecock during the serving action. In general, the faster the serve speed, the faster the shuttlecock can fly across the net, and the player needs a faster response speed to return the shuttlecock. The serve frequency refers to the number of consecutive serves within a period of time. The higher the frequency, the player needs to continuously respond in a short period of time, which can strengthen concentration of the player. The horizontal serve position refers to the position where the shuttlecock is served in the horizontal direction. The parameter of the horizontal serve position affects the flying trajectory of the shuttlecock, thereby making it more challenging for the player to move in the horizontal direction. The vertical serve position refers to the position where the shuttlecock is served in the vertical direction. The parameter of the vertical serve position affects the flying trajectory of the shuttlecock, thereby affecting the way the player returns the shuttlecock.

In one application, the computing device 14 can communicate with the serving device 12 through AIoT (Artificial Intelligence of Things) to control the serving device 12 to serve the shuttlecock to the vacancy region with respect to the player A. The player A can define the above-mentioned serve parameters by himself, and store the self-defined serve parameters in a database, such as in the memory unit 142 of the computing device 14 or a cloud database of a cloud device, so that the stored serve parameters can be accessed, modified and used at any time in the future. This function of customizing serve parameters helps the player A to continue to challenge himself during the training process, try different shuttlecock serve path settings, create more challenging shuttlecock serve paths, and improve personal skill level and response ability.

After the serving device 12 serves the shuttlecock B toward the vacancy region of player A on the first half court Z1, and the shuttlecock B is returned by the player A, referring to FIG. 3 again, the third procedure P3 is performed to obtain the image of the shuttlecock B returned by the player A until falling on the landing point on the second half court Z2, and to determine whether the landing point is out of bounds. As shown in FIG. 4, in the third procedure P3, the step of determining whether the landing point is out of bounds includes a court boundary detection step S1 and a landing point detection step S2. The court boundary detection step S1 includes: obtaining an image of the second half court, and obtaining boundary information based on the image of the second half court, thereby obtaining boundary lines, intersection coordinates and an inbound area of the second half court (step S11); and dividing the inbound area into multiple blocks and obtaining coordinates of the blocks (step S12). The landing point detection step S2 includes: detecting a flying trajectory of the shuttlecock (step S21); and determining whether the landing point is out of bounds based on a result of the court boundary detection step and the flying trajectory of the shuttlecock (step S22).

Specifically, in the court boundary detection step S1, a first frame is firstly obtained from the images of the badminton court Z captured by the first image capturing devices 13a and 13b and is used as the input for court boundary detection, wherein the first frame includes the image of the court (the second half court Z2) only and the boundaries are not blocked by the player or other objects (e.g. the serving device 12). Then, the boundary intersection determination algorithm is used to obtain the boundary information of the second half court Z2, and then the boundary lines of the second half court Z2 can be obtained through a computer vision processing method. Next, all coordinates of the second half court Z2 are recorded and drawn. Afterwards, the intersection coordinates of the boundary lines are found through a corner detection algorithm so as to obtain the inbound area of the half court (the second half court Z2). Finally, as shown in FIG. 8, the inbound area is divided into, for example, 16 blocks Z21 (the areas of the 16 blocks Z21 are not all the same), and the coordinates of these 16 blocks Z21 are obtained for the references of subsequent calculations of the landing point.

In the landing point detection step S2, an object detection algorism based on deep learning, such as YOLOv3 (You Only Look Once, Version 3) model, is used to detect the flying trajectory of the shuttlecock B. By changing the structure size of the deep learning model and adding a multi-scale prediction method, compared with the previous generation prediction method, the YOLOv3 model can have the improved computing speed, better detection effect, and improved detection effect on small objects. In this case, the flying trajectory of the shuttlecock B includes the flying trajectory of the served shuttlecock B and the returned shuttlecock B as well as the landing points. The system of this embodiment uses the YOLOv3 model to detect the flying trajectory of the shuttlecock B, and then utilizes the result of the court boundary detection step S1 to determine whether the landing point of the shuttlecock B is in or out of bounds. That is, the flying trajectory and landing point of the shuttlecock B are detected in advance, and then the result of the court boundary detection step S1 is used to determine whether the coordinates of the landing point of the shuttlecock B are out of bounds or not. If the landing point is determined as inbounds, the player can score for one point; and if the landing point is determined as out of bounds, the player does not score. In addition, if the player A does not return or hit the served shuttlecock B, the player also does not score.

In the third procedure P3, after the player A returned the shuttlecock B, the one or more processing units 141 further perform: tracking position changes of the player A on projected images of sequential frames to obtain a running distance of the player A in the period of returning the shuttlecock B. Specifically, in order to evaluate the running distance of the player A, the aforementioned ByteTrack tracker is also used to track the position changes of the player A on the projected images of sequential frames, and then the position changes are mapped to the above-mentioned top view diagram so as to obtain the actual running distance. Since international badminton courts have standard sizes, the computing device 14 can use the standard size of the badminton court as a reference to obtain the distance ratio in the projected image, and use this ratio to accurately and instantly calculate the actual running distance of the player A on the badminton court, thereby obtaining the running distance of the player A in the period of returning the shuttlecock B.

Referring to FIG. 3, after determining whether the landing point is out of bounds, the one or more processing units 141 further repeat the first procedure P1, the second procedure P2, and the third procedure P3 until reaching a stop condition. In this embodiment, the stop condition can be, for example, reaching the end of a period of time (e.g. 10 minutes, 15 minutes, or 20 minutes), or serving, for example, 50 or 100 shuttlecocks by the serving device 12.

Finally, the one or more processing units 141 can further perform a fourth procedure P4 of: generating a smart badminton shot report according to the sensing signal and the landing points of the returned shuttlecocks. In one embodiment, the smart badminton shot report may include scoring shots. Regarding the detection of scoring shots, the images of the shuttlecock B returned by the player A are analyzed to determine whether the returned shuttlecock B is landed on the inbounds area of the second half court Z2. However, since the serving device 12 is arranged on the second half court Z2, the images of the returned shuttlecock B may be blocked by the serving device 12, which can result to the failure of determining the landing point of the shuttlecock B (failure of detection of scoring shot). In order to solve this issue, the one or more processing units 141 may further analyze the sensing signal SS outputted by the signal sensing device 111 and calculate a strike parameter corresponding to the strike motion of the player A. Specifically, the badminton intelligent training evaluation system 1 of this embodiment analyzes the sensing signal SS outputted by the signal sensing device 111 (inertial sensor) installed on the handle of the badminton racket 11 so as to detect and determine whether the shuttlecock B is successfully returned. The computing device 14 can conduct a deep analysis of the sensing signal SS (inertial signal) to obtain, for example, the swing speed and swing strength, to determine whether the shuttlecock B is hit and whether it is an efficient shot, and to identify the shot type of the strike motion. To be noted, the detailed descriptions of analyzing the sensing signal SS (inertial signal) to obtain the strike parameters such as the shot type of strike motion, the swing speed, the swing strength, the swing efficiency, the initial speed of returned shuttlecock, and the likes can be referred to Taiwan Patent No. TWI770787 entitled “HAND-HELD MOTION ANALYSIS SYSTEM AND METHOD”.

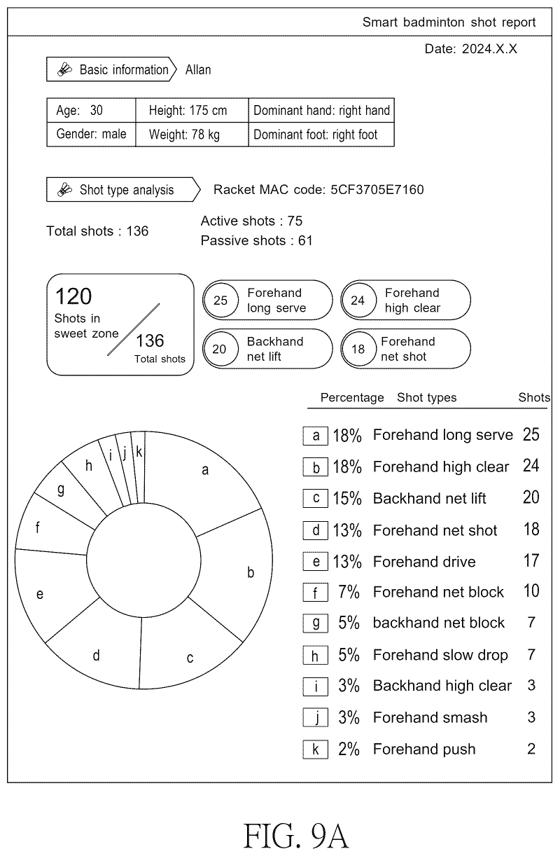

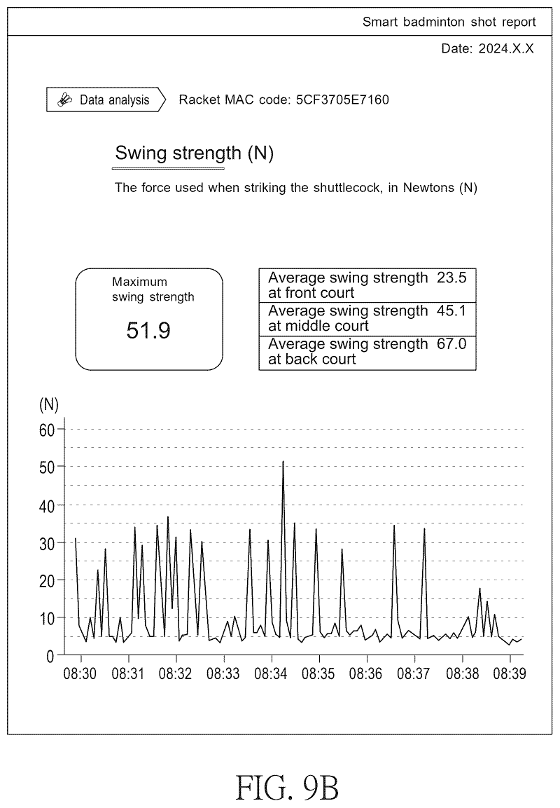

FIGS. 9A and 9B are schematic diagrams showing the smart badminton shot reports of the player. FIG. 9A shows the shot type of strike motions, the shot times of each shot type, and the ratio of each shot type, and FIG. 9B shows the average swing strength, the maximum swing strength, and the changes in swing strength at different time points. To be noted, the smart badminton shot report is not limited to those shown in FIGS. 9A and 9B. In practice, the smart badminton shot report can show different strike results according to the needs of the player, and can show the comparison of different players. The contents of the smart badminton shot report of this disclosure are not limited.

In addition, if the player A wears the sports shoes disclosed by Taiwan Patent Application No. 112211288 entitled “MOTION SENSING DEVICE AND SPORTS SHOES”, the step recognition, movement ability evaluation, and strike stability can also be analyzed at the same time.

In one embodiment, the one or more computing units 141 can further perform: playing the image of the strike motion of the player A. In this case, the technical content of the replay of the image of returning the shuttlecock B by the player A can be referred to the disclosure disclosed by Taiwan Patent Application No. 112145387 entitled “SYSTEM AND METHOD FOR AUTOMATICALLY CAPTURING AND REPLAYING IMAGES, AND STORAGE MEDIUM”. In one embodiment, the computing device 14 can directly replay the image of returning the shuttlecock B, or indirectly replay the image through a playing device, and can further directly or indirectly show the aforementioned smart badminton shot report.

As mentioned above, the badminton intelligent training evaluation system 1 of this embodiment combines the serving device 12 with AIoT, and controls the serve parameter of the serving device 12 through the computing device 14, thereby carrying out the combination of customized shuttlecock serve paths. Accordingly, the shuttlecock can be served in the designated shuttlecock serve path toward the vacancy regions of the player, thereby increasing the difficulty of returning the shuttlecock. In addition, the running distance of the player on the badminton court can also be calculated as an objective athletic ability indicator of the badminton players. Moreover, this system develops the score detection of the returned shuttlecock through detecting and determining whether the landing point of the returned shuttlecock is within the inbounds area or is out of bounds, thereby determining whether the return shot is success or not. After training, the above-mentioned smart badminton shot report can be provided to the player for reference.

In one embodiment, the strike result analysis data of the player can be compared with the big data of other players with using the same combination of shuttlecock serve paths, thereby helping the player understand his exercise performance. Based on these data, athletes (badminton players) can refine their training program, improve their skills, and enhance the overall training effect.

In one embodiment, in order to allow the general public or advanced players to have a competitive-like experience during practice or exercise, this system can collect the relevant sports values of professional players and compare the collected sports values with the analysis data of general public or advanced players through the technical parameters calculated by the algorithm, so that the general public or advanced players can quickly realize the deficient parts (skills) thereof. Moreover, the general public or advanced players can do more trainings on the deficient parts (skills) so as to optimize their ability to execute tactics. For example, the general public or advanced players may specifically train the swing motion to reduce the redundant moves so as to improve the swing speed. For the advanced players, it is expected to include the sports values of many top professional players. For example, the sports values of a top professional player, who is very sensitive in selecting the type of returning shot, has a brisk pace to execute his/her tactics perfectly, often uses fake moves with superb offensive skills to disrupt the opponent's rhythm and score, especially using his/her excellent physical fitness to execute a variety of assault tactics so as to cause the opponent to lose points due to the rapid decline in physical strength and being unable to counterattack quickly, are collected with priority. This system can conduct more efficient training through comparison of skill parameters and enhance personal deficiencies, thereby cultivating more excellent badminton players.

In addition, this disclosure also provides a badminton intelligent training evaluation method, which is applied to the above-mentioned badminton intelligent training evaluation system 1 for training and evaluating an exercising result of a player. The component configurations and functions of the badminton intelligent training evaluation system 1 can be referred to the above embodiment, so the detailed descriptions thereof will be omitted.

The badminton intelligent training evaluation method of this embodiment at least includes the following steps.

The first step is to obtain and analyze the image of the player A on the first half court Z1 to obtain a vacancy region with respect to the player A instantly. The second step is to control the serving device 12 to serve the shuttlecock B to fall in the vacancy region according to the obtained vacancy region. The third step is to obtain the image of the shuttlecock B returned by the player A until falling on the landing point on the second half court Z2, and to determine whether the landing point is out of bounds. In addition, the badminton intelligent training evaluation method of this embodiment further includes a fourth step of: generating a smart badminton shot report according to the sensing signal SS and the landing points of the returned shuttlecocks B.

In one embodiment, before the first step of obtaining the vacancy region, the badminton intelligent training evaluation method further includes: obtaining an image of the first half court Z1 by the first image capturing devices 13a and 13b and marking corner points CP of the first half court Z1 based on the obtained image of the first half court Z1; and mapping the corner points CP of the first half court Z1 to a top view diagram of the first half court Z1 so as to establish a coordinate base for detecting a position of the player A on the top view diagram.

In one embodiment, in the third step of obtaining the image of the shuttlecock B returned by the player A, the badminton intelligent training evaluation method further includes: tracking position changes of the player A on projected images of sequential frames to obtain a running distance of the player A in a period of returning the shuttlecock B. In one embodiment, the step of determining whether the landing point is out of bounds includes a court boundary detection step S1 and a landing point detection step S2. The court boundary detection step S1 includes: obtaining an image of the second half court Z2, and obtaining boundary information based on the image of the second half court Z2, thereby obtaining boundary lines, intersection coordinates and an inbound area of the second half court Z2 (step S11); and dividing the inbound area into multiple blocks Z21 and obtaining coordinates of the blocks Z21 (step S12). The landing point detection step S2 includes: detecting a flying trajectory of the shuttlecock B; and determining whether the landing point is out of bounds based on a result of the court boundary detection step and the flying trajectory of the shuttlecock B.

In one embodiment, the badminton intelligent training evaluation method further includes: analyzing the sensing signal SS and calculating a strike parameter corresponding to the strike motion of the player A. In one embodiment, the badminton intelligent training evaluation method further includes: playing the image of the strike motion of the player A.

The first step to the fourth step of the above-mentioned badminton intelligent training evaluation method and the other technical contents thereof can be referred to the first procedure P1 to the fourth procedure P4 and the corresponding technical descriptions, so the detailed descriptions thereof will be omitted.

Moreover, the present disclosure further provides a storage medium storing an application software, and an electronic device may load and execute the application software to perform the above-mentioned badminton intelligent training evaluation method. In this embodiment, the device can be any type of electronic device, such as a computer, a server or a mobile electronic device. In one embodiment, the storage medium may be a non-transitory computer-readable storage medium, which may at least include, for example, a memory unit, a memory card, an optical disc, a video tape, a computer tape, or any combination thereof. The memory unit may include read-only memory (ROM), flash memory, field-programmable gate array (FPGA), or solid-state disk (SSD), or other forms of memory unit, or a combination thereof. In one embodiment, the storage medium can be a built-in memory of a computer or a server. In one embodiment, the storage medium can be a cloud memory located in a cloud device. In this case, the application software can be stored in the cloud device, and then the electronic device can download the application software from the cloud device and execute it to implement the badminton intelligent training evaluation method.

In summary, the badminton intelligent training evaluation system and method of this disclosure includes the following steps of: obtaining and analyzing the image of the player on the first half court to obtain a vacancy region with respect to the player instantly; controlling the serving device to serve the shuttlecock to fall in the vacancy region according to the obtained vacancy region; and obtaining the image of the shuttlecock returned by the player until falling on the landing point on the second half court, and determining whether the landing point is out of bounds. Therefore, the badminton intelligent training evaluation system and method of this disclosure can instantly obtain the player's location for enhancing intelligent serving technology, and determine the landing point of the returned shuttlecock, which is used as a reference for evaluating whether the returned shot is success or not, thereby creating a new intelligent badminton experience.

Although the disclosure has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the disclosure.

What is claimed is:

1. A badminton intelligent training evaluation system, applied to a badminton court for training and evaluating an exercising result of a player, wherein the badminton court comprises two badminton net stands and a badminton net hanged between the badminton net stands, and the badminton court is divided by the badminton net into a first half court and a second half court, the badminton intelligent training evaluation system comprising:
a badminton racket comprising a signal sensing device, wherein the signal sensing device senses a strike motion of the player with holding the badminton racket on the first half court and outputs a sensing signal;
a serving device arranged at the second half court for serving at least one shuttlecock to the first half court;
two first image capturing devices respectively disposed on the badminton net stands, wherein the first image capturing devices obtain an image of the player on the first half court and an image of the shuttlecock returned by the player until falling on a landing point on the second half court; and
a computing device communicational connected to the signal sensing device, the serving device and the first image capturing devices, wherein the computing device comprises one or more processing units and a memory unit, the one or more processing units are coupled to the memory unit, the memory unit stores one or more instructions, and the one or more processing units, when executing the one or more instructions, perform:
a first procedure of obtaining and analyzing the image of the player on the first half court to obtain a vacancy region with respect to the player instantly;
a second procedure of controlling the serving device to serve the shuttlecock to fall in the vacancy region according to the obtained vacancy region; and
a third procedure of obtaining the image of the shuttlecock returned by the player until falling on the landing point on the second half court, and determining whether the landing point is out of bounds.

2. The badminton intelligent training evaluation system of claim 1, wherein before obtaining the vacancy region in the first procedure, the one or more processing units further perform:
obtaining an image of the first half court by the first image capturing devices and marking corner points of the first half court; and
mapping the corner points of the first half court to a top view diagram of the first half court so as to establish a coordinate base for detecting a position of the player on the top view diagram.

3. The badminton intelligent training evaluation system of claim 1, wherein the vacancy region comprises a positional vacancy region and a dynamic vacancy region, the positional vacancy region is a region on the first half court farthest from the player, and the dynamic vacancy region is a region on the first half court opposite to a fast moving direction of the player.

4. The badminton intelligent training evaluation system of claim 1, wherein in the second procedure, the computing device controls a serve parameter of the serving device to make the shuttlecock fall within the vacancy region, and the serve parameter comprises a serve speed, a serve frequency, a horizontal serve position and a vertical serve position.

5. The badminton intelligent training evaluation system of claim 4, wherein the serve parameter is stored in the memory unit of the computing device or a cloud database.

6. The badminton intelligent training evaluation system of claim 1, wherein after the player returns the shuttlecock in the third procedure, the one or more processing units further perform:
tracking position changes of the player on projected images of sequential frames to obtain a running distance of the player in a period of returning the shuttlecock.

7. The badminton intelligent training evaluation system of claim 1, wherein the step of determining whether the landing point is out of bounds in the third procedure comprises a court boundary detection step and a landing point detection step;
wherein, the court boundary detection step comprises:
obtaining an image of the second half court, and obtaining boundary information based on the image of the second half court, thereby obtaining boundary lines, intersection coordinates and an inbound area of the second half court, and
dividing the inbound area into multiple blocks and obtaining coordinates of the blocks; and
wherein, the landing point detection step comprises:
detecting a flying trajectory of the shuttlecock, and
determining whether the landing point is out of bounds based on a result of the court boundary detection step and the flying trajectory of the shuttlecock.

8. The badminton intelligent training evaluation system of claim 1, wherein the one or more processing units further perform:
analyzing the sensing signal and calculating a strike parameter corresponding to the strike motion of the player.

9. The badminton intelligent training evaluation system of claim 1, further comprising a second image capturing device for obtaining an image of the strike motion of the player and an image of the flying shuttlecock, wherein the one or more processing units further perform:
playing the image of the strike motion of the player.

10. The badminton intelligent training evaluation system of claim 1, wherein the one or more processing units further perform:
repeating the first procedure, the second procedure and the third procedure until reaching a stop condition.

11. The badminton intelligent training evaluation system of claim 1, wherein the serving device serves a plurality of the shuttlecocks, and the one or more processing units further perform:
a fourth procedure of generating a smart badminton shot report according to the sensing signal and the landing points of the returned shuttlecocks.

12. A badminton intelligent training evaluation method, applied to a badminton intelligent training evaluation system for training and evaluating an exercising result of a player, wherein the badminton intelligent training evaluation system is applied to a badminton court, the badminton court comprises two badminton net stands and a badminton net hanged between the badminton net stands, and the badminton court is divided by the badminton net into a first half court and a second half court, the badminton intelligent training evaluation system comprises a badminton racket, a serving device, two first image capturing devices and a computing device, the badminton racket comprises a signal sensing device, the signal sensing device senses a strike motion of the player with holding the badminton racket on the first half court and outputs a sensing signal, the serving device is arranged at the second half court for serving at least one shuttlecock to the first half court, the first image capturing devices are respectively disposed on the badminton net stands, and obtain an image of the player on the first half court and an image of the shuttlecock returned by the player until falling on a landing point on the second half court, and the computing device is communicational connected to the signal sensing device, the serving device and the first image capturing devices, the badminton intelligent training evaluation method comprising:
obtaining and analyzing the image of the player on the first half court to obtain a vacancy region with respect to the player instantly;
controlling the serving device to serve the shuttlecock to fall in the vacancy region according to the obtained vacancy region; and
obtaining the image of the shuttlecock returned by the player until falling on the landing point on the second half court, and determining whether the landing point is out of bounds.

13. The badminton intelligent training evaluation method of claim 12, wherein before the step of obtaining the vacancy region, the badminton intelligent training evaluation method further comprises:
obtaining an image of the first half court by the first image capturing devices and marking corner points of the first half court based on the obtained image of the first half court; and
mapping the corner points of the first half court to a top view diagram of the first half court so as to establish a coordinate base for detecting a position of the player on the top view diagram.

14. The badminton intelligent training evaluation method of claim 12, wherein the vacancy region comprises a positional vacancy region and a dynamic vacancy region, the positional vacancy region is a region on the first half court farthest from the player, and the dynamic vacancy region is a region on the first half court opposite to a fast moving direction of the player.

15. The badminton intelligent training evaluation method of claim 12, wherein the computing device controls a serve parameter of the serving device to make the shuttlecock fall within the vacancy region, and the serve parameter comprises a serve speed, a serve frequency, a horizontal serve position and a vertical serve position.

16. The badminton intelligent training evaluation method of claim 12, in the step of obtaining the image of the shuttlecock returned by the player, further comprising:
tracking position changes of the player on projected images of sequential frames to obtain a running distance of the player in a period of returning the shuttlecock.

17. The badminton intelligent training evaluation method of claim 12, wherein the step of determining whether the landing point is out of bounds comprises a court boundary detection step and a landing point detection step;
wherein, the court boundary detection step comprises:
obtaining an image of the second half court, and obtaining boundary information based on the image of the second half court, thereby obtaining boundary lines, intersection coordinates and an inbound area of the second half court, and
dividing the inbound area into multiple blocks and obtaining coordinates of the blocks; and
wherein, the landing point detection step comprises:
detecting a flying trajectory of the shuttlecock, and
determining whether the landing point is out of bounds based on a result of the court boundary detection step and the flying trajectory of the shuttlecock.

18. The badminton intelligent training evaluation method of claim 12, further comprising:
analyzing the sensing signal and calculating a strike parameter corresponding to the strike motion of the player.

19. The badminton intelligent training evaluation method of claim 12, wherein the serving device serves a plurality of the shuttlecocks, and the badminton intelligent training evaluation method further comprises:
generating a smart badminton shot report according to the sensing signal and the landing points of the returned shuttlecocks.

20. A non-transitory computer readable storage medium storing an application software, an electronic device loading and executing the application software to perform a badminton intelligent training evaluation method, which is applied to a badminton intelligent training evaluation system for training and evaluating an exercising result of a player, wherein the badminton intelligent training evaluation system is applied to a badminton court, the badminton court comprises two badminton net stands and a badminton net hanged between the badminton net stands, and the badminton court is divided by the badminton net into a first half court and a second half court, the badminton intelligent training evaluation system comprises a badminton racket, a serving device, two first image capturing devices and a computing device, the badminton racket comprises a signal sensing device, the signal sensing device senses a strike motion of the player with holding the badminton racket on the first half court and outputs a sensing signal, the serving device is arranged at the second half court for serving at least one shuttlecock to the first half court, the first image capturing devices are respectively disposed on the badminton net stands, and obtain an image of the player on the first half court and an image of the shuttlecock returned by the player until falling on a landing point on the second half court, the computing device is communicational connected to the signal sensing device, the serving device and the first image capturing devices, and the badminton intelligent training evaluation method comprises:
obtaining and analyzing the image of the player on the first half court to obtain a vacancy region with respect to the player instantly;
controlling the serving device to serve the shuttlecock to fall in the vacancy region according to the obtained vacancy region; and
obtaining the image of the shuttlecock returned by the player until falling on the landing point on the second half court, and determining whether the landing point is out of bounds.
